(19) United States
(12) Patent Application Publication
(10) Pub. No.: US 2017/0111253 A1
(43) Pub. Date: Apr. 20, 2017

(54) IDENTIFYING POTENTIAL DATA TRANSFER INTERRUPTION AT WIRELESS CLIENT DEVICE

(71) Applicant: ARRIS Enterprises, Inc., Suwanee, GA (US)

(72) Inventors: Praveen Girish, Bangalore (IN); Krishna Prasad Panje, Bangalore (IN)

(21) Appl. No.: 14/887,827

(22) Filed: Oct. 20, 2015

(51) Int. Cl. H04L 12/26; G08B 21/18; H04W 4/02

(52) U.S. Cl. CPC H04L 43/0876; H04L 43/16; H04W 4/02; G08B 21/182

(57) ABSTRACT

Methods, systems, and computer readable media may be operable to facilitate the output of an alert to a client device informing a user of a potential disruption to a data transfer at a client device. An access point may monitor the data rate of a data transfer session with a station, determine a minimum data transfer rate threshold for the data transfer session, and output an alert to the station when the data rate of the transfer session drops below the minimum data transfer rate threshold. The reduced data rate may be caused by a movement of the station away from the access point, and the alert may provide a user with an indication of the reduced data rate. In embodiments, the alert may provide the user with instructions or recommendations for remedying or preventing an interruption to the transfer session.

### TECHNICAL FIELD

This disclosure relates to proactive prevention of a data transfer interruption at a wireless client device.

### BACKGROUND

It is commonplace that multimedia content is shared between multiple subscriber devices. For example, a central device such as a gateway device or set-top box may be configured to share multimedia content stored on the device with mobile client devices such as a smart phone or tablet. Content that is recorded at a central device may be transcoded to a format that is compatible with one or more client devices, and the transcoded content may be transferred to one or more of the client devices. For example, a client device may be synchronized with a central device, wherein content stored at the central device is transferred to the client device for later consumption by a user.

A user may select content of interest at a central device, and the selected content of interest may be processed or transcoded according to the playback attributes of a client device designated for receiving the content (e.g., mobile device, tablet, etc.). After the content is transcoded to suit the needs of the client device, the transcoded content may be transferred to the client device. Where both the central device and client device have wireless capabilities, the content may be transferred to the client device over a wireless network. The transcode and transfer processes may be time consuming and may be carried out by the central device as background processes over an extended period of time.

Depending on the size of the requested content and the bandwidth available on a wireless network, the content transfer task may be a time-consuming task, and both the transferring device (e.g., central device such as a media gateway device) and receiving device (e.g., mobile client device) are expected to stay connected until the transfer task is complete. Typically, the connection between a mobile client device and central device is a wireless connection and is dependent upon the proximity of the client device to the central device. For example, as the distance between the client device and central device grows, the strength of the communication signal between the client device and central device weakens, and when the client device is far enough away from the central device, the connection between the client device and central device may be lost all together.

Typically, mobile client devices are moved throughout a customer premise on a fairly regular basis, thus the proximity of a mobile client device to a central device may oftentimes be changing. When a client device is moved during a content transfer session between the client device and a central device, the data rate of the content transfer may be negatively impacted as the signal strength between the client device and central device (or access point associated with the central device) weakens when the client device is moved away from the central device (or access point). For example, a content transfer session may be initiated between a mobile device and central device while the mobile device is in a user's pocket. As the user moves throughout the customer premise during the transfer session, the data rate of the transfer session may be reduced as the user moves away from the central device, and the transfer session may be interrupted completely if the user moves to a location that is out of the wireless range of the central device. Moreover, because the efficiency of a wireless data transfer is dependent on the strength of a signal between the transferring device and receiving device, a content transfer between a central device and client device may take longer than expected to complete where the client device is in a location receiving a weak signal from the central device.

At times, a user may not be aware that a content transfer session is ongoing between a client device and central device, and the content may not be transferred to the client device if the transfer session is interrupted by the movement of the client device away from the central device. Therefore, a need exists for methods and systems operable to facilitate alerting a user of a potential interruption to a data transfer session.

### BRIEF DESCRIPTION OF THE DRAWINGS

FIG. 1 is a block diagram illustrating an example network environment operable to facilitate the output of an alert to a client device informing a user of a potential disruption to a data transfer at a client device.

FIG. 2 is a block diagram illustrating an example access point operable to facilitate the output of an alert to a client device informing a user of a potential disruption to a data transfer at a client device.

FIG. 3 is a flowchart illustrating an example process operable to facilitate an output of an alert to a client device informing the client device of a potential data transfer disruption.

FIG. 4 is a flowchart illustrating an example process operable to facilitate an output of an alert to a client device informing the client device of a potential data transfer disruption when the data transfer has progressed past a certain threshold level.

FIG. 5 is an example notification that may provide an indication to a user that a current data transfer may potentially be disrupted.

FIG. 6 is a block diagram of a hardware configuration operable to facilitate the output of an alert to a client device informing a user of a potential disruption to a data transfer at a client device.

Like reference numbers and designations in the various drawings indicate like elements.

### DETAILED DESCRIPTION

It is desirable to provide methods and systems operable to facilitate alerting a user of a potential interruption to a data transfer session. Methods, systems, and computer readable media may be operable to facilitate the output of an alert to a client device informing a user of a potential disruption to a data transfer at a client device. An access point may monitor the data rate of a data transfer session with a station, determine a minimum data transfer rate threshold for the data transfer session, and output an alert to the station when the data rate of the transfer session drops below the minimum data transfer rate threshold. The reduced data rate may be caused by a movement of the station away from the access point, and the alert may provide a user with an indication of the reduced data rate. In embodiments, the alert may provide the user with instructions or recommendations for remedying or preventing an interruption to the transfer session.

An embodiment of the invention described herein may include a method comprising: (a) monitoring the data rate of a data transfer session, wherein the data transfer session comprises an output of a plurality of data packets to a station, the plurality of data packets being output to the station over a wireless interface; (b) determining a minimum data rate threshold associated with the data transfer session, wherein the minimum data rate threshold indicates a potential for an interruption to the data transfer session; (c) determining a current data rate associated with the data transfer session; and (d) if the current data rate associated with the data transfer session is less than the minimum data rate threshold, outputting an alert to the station, wherein the alert provides an indication of the potential for an interruption to the data transfer session.

According to an embodiment of the invention, the alert causes an audible indication to be output from the station, the audible indication serving to inform a user that the data transfer session may be interrupted due to the current location of the station with respect to an associated access point.

According to an embodiment of the invention, the alert causes a visual indication to be output from the station, the visual indication comprising a notification informing a user that the data transfer session may be interrupted due to the current location of the station with respect to an associated access point, and the visual indication may further comprise one or more suggestions for moving the station to prevent the potential interruption to the data transfer session and/or a notification instructing the user to move the station closer in proximity to an associated access point.

According to an embodiment of the invention, the method described above further comprises: (a) determining an average data rate associated with the data transfer session; and (b) wherein the minimum data rate threshold is based on the average data rate associated with the data transfer session.

According to an embodiment of the invention, the method described above further comprises: (a) determining a current progress level associated with the data transfer session; and (b) if the current progress level associated with the data transfer session is below a predetermined threshold progress level, withholding the output of the alert to the station.

An embodiment of the invention described herein may include an apparatus comprising: (a) a wireless interface configured to be used to output a plurality of data packets to a station as part of a data transfer session with the station; (b) one or more modules configured to: (i) monitor the data rate of the data transfer session; (ii) determine a minimum data rate threshold associated with the data transfer session, wherein the minimum data rate threshold indicates a potential for an interruption to the data transfer session; (iii) determine a current data rate associated with the data transfer session; and (iv) determine that the current data rate associated with the data transfer session is less than the minimum data rate threshold; and (c) an interface configured to be used to output an alert to the station, wherein the alert provides an indication of the potential for an interruption to the data transfer session.

An embodiment of the invention described herein may include one or more non-transitory computer readable media having instructions operable to cause one or more processors to perform the operations comprising: (a) monitoring the data rate of a data transfer session, wherein the data transfer session comprises an output of a plurality of data packets to a station, the plurality of data packets being output to the station over a wireless interface; (b) determining a minimum data rate threshold associated with the data transfer session, wherein the minimum data rate threshold indicates a potential for an interruption to the data transfer session; (c) determining a current data rate associated with the data transfer session; and (d) if the current data rate associated with the data transfer session is less than the minimum data rate threshold, outputting an alert to the station, wherein the alert provides an indication of the potential for an interruption to the data transfer session.

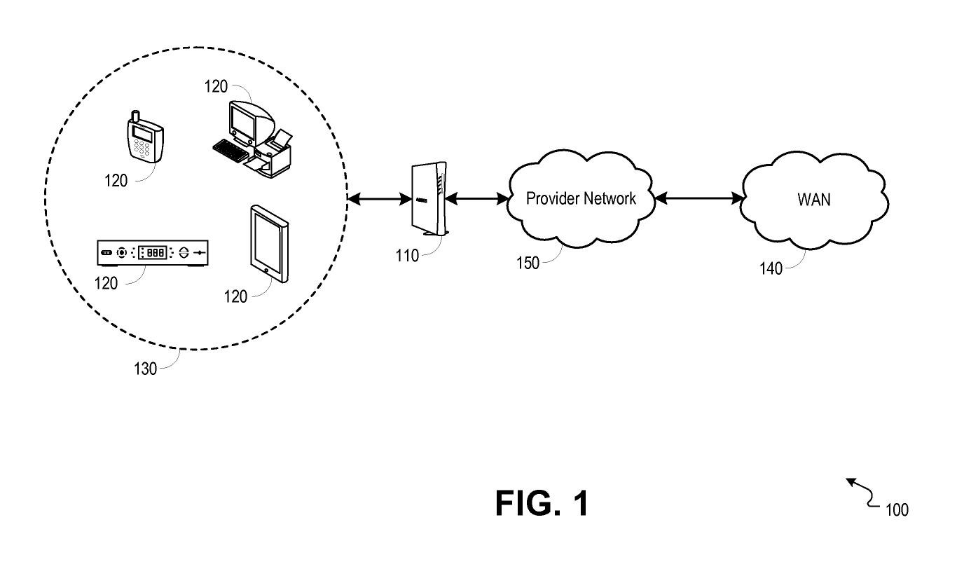

FIG. 1 is a block diagram illustrating an example network environment 100 operable to facilitate the output of an alert to a client device informing a user of a potential disruption to a data transfer at a client device. In embodiments, an access point 110 (e.g., gateway or media gateway device, modem, wireless router including an embedded modem, wireless network extender, etc.) coupled with one or more stations 120 (e.g., customer premise equipment (CPE) devices such as a set-top boxes (STB) or client devices such as computers, televisions, mobile devices, tablets, etc.) may provide video, data, and/or telephony services to a subscriber. An access point 110 may communicate with one or more stations 120 over a local network 130 (e.g., a local area network (LAN), a wireless local area network (WLAN), a personal area network (PAN), etc.) and may communicate with an upstream wide area network (WAN) 140 through a connection to a provider network 150.

In embodiments, an access point 110 may communicate with a station 120 over a wired or a wireless connection. An access point 110 may provide one or more channels or service sets through which services and communications may be delivered wirelessly to one or more stations 120. A station 120 may associate and authenticate with an access point 110, after which communications and services may be delivered from the access point 110 to the station 120. It should be understood that various protocols and/or standards (e.g., Wi-Fi, multimedia over coax alliance (MoCA), ZigBee etc.) may be used to deliver communications between an access point 110 and station 120.

An access point 110 may output live or linear content to a station 120 as the content is received at the access point 110, or the access point 110 may store content and output the stored content to a station 120 at a later time. For example, content may be transcoded and stored at the access point 110, wherein the content is transcoded into a format that is compatible with one or more stations 120. The access point 110 may carry out a data transfer or synchronization operation with an associated station 120, wherein linear or stored content is wirelessly transferred to the station 120. The access point 110 may output content to a station 120 when the content is requested or at a scheduled time.

The rate at which content is transferred to a station 120 may depend on various factors including, but not limited to the transmission strength of the access point 110, the strength of the signal between the access point 110 and station 120, the size of the piece of content being transferred, a priority level associated with the piece of content being transferred, bandwidth available to the access point 110, and others. The strength of the signal between an access point 110 and station 120 may be based upon various factors such as the distance between the access point 110 and station 120 as well as the presence of any obstacles (e.g., walls) between the access point 110 and station 120. The strength of the signal between the access point 110 and station 120 may change during a data transfer session, especially when the station 120 is a mobile device (e.g., tablet, mobile telephone, mobile set-top box, etc.), thereby reducing the data rate of the session or potentially disrupting the session all together. For example, if a user carries a mobile station 120 away from an access point 110 during a data transfer session, the signal strength between the station 120 and access point 110 may begin to weaken, thereby causing the data rate of the transfer session to diminish. If the user carries the mobile station 120 far enough away from the access point 110, the signal between the station 120 and access point 110 may be lost, and the transfer session may be terminated.

In embodiments, the access point 110 may monitor the data rate (e.g., bit rate) of the transfer of data to a station 120. Based on the observed data rate of the transfer session, the access point 110 may determine a minimum data transfer rate threshold for the transfer session. It should be understood that the minimum data transfer rate threshold may be further based on various other factors such as an average data rate observed for the transfers session, the current signal strength between the access point 110 and station 120, the progress of the transfer session, and others. If, during the data transfer session, the observed data rate of the session drops below the minimum data transfer threshold, the access point 110 may output an alert to the station 120 or to a device associated with the station 120 (e.g., display device), wherein the alert provides an indication to a user that the current signal strength between the station 120 and access point 110 may cause an interruption to the current data transfer session. For example, the alert may be a visual output (e.g., graphic, animated graphic, text, etc.) or an audio output (e.g., beep, ringtone, etc.). The alert may be output to the station 110 and presented to a user until the data rate returns to a level higher than the minimum data transfer rate threshold. It should be understood that an alert may be delivered from the access point 110 to a station 120 as any of a variety of message types (e.g., hypertext transfer protocol (HTTP), extensible markup language (XML), representational stat transfer (REST), etc.).

In embodiments, the alert may include instructions or suggestions to assist a user in remedying or preventing the potential disruption to the transfer session. For example, a visual notification may guide a user to a location within a premise where the strength of the signal between the access point 110 and station 120 may be stronger. The visual notification may provide a user with an indication of the current strength of the signal between the access point 110 and the station 120 and may further include an indication of the progress of the current data transfer session.

In embodiments, the alert may provide a user with a notification that a scheduled transfer of content to the station 120 will not be possible based on the current signal strength (e.g., a possible rate of a data transfer may be deduced from the signal strength) between the access point 110 and station 120. For example, an alert may be output when a scheduled content transfer is not going to meet a predetermined timeframe because of throughput drop or interruption.

In embodiments, the output of an alert indicating a potential disruption to the current transfer session may be based upon the progress of the transfer session. For example, the alert may be output to a station 120 or other device associated with the station 120 to which content is being transferred when the data rate of the data transfer falls below the minimum data transfer rate threshold associated with the transfer session and the data transfer session has progressed past a predetermined threshold progress level (e.g., 75%, 80%, 90%, etc.). The threshold progress level may be based upon the size of the content being transferred, a priority level associated with the piece of content, or other factors.

In embodiments, various settings associated with the output of an alert to a station 120 may be configured by a user. For example, a user may configure an access point 110 to output an alert to a station 120 for an interruption of certain types or genres of contents or an interruption of certain prioritized content. In embodiments, the access point 110 may be configured to output an alert to a station 120 in order to provide a user with instructions or suggestions for moving the station 120 to improve the data rate of the current transfer session. For example, the alert may be output to a station 120 whenever the monitored data rate of the transfer session is less than a maximum or optimal data rate associated with the data transfer session.

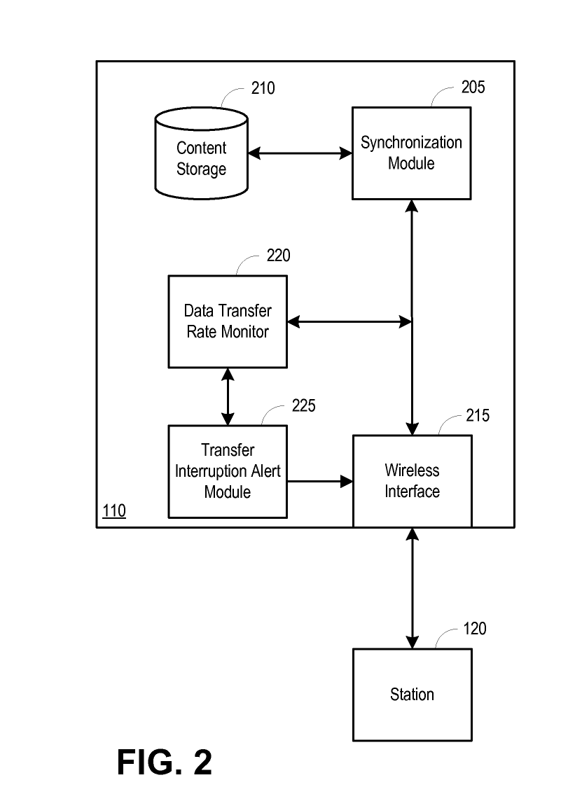

FIG. 2 is a block diagram illustrating an example access point 110 operable to facilitate the output of an alert to a device informing a user of a potential disruption to a data transfer at a station 120. The access point 110 may include a synchronization module 205, content storage 210, a wireless interface 215, a data transfer rate monitor 220, and a transfer interruption alert module 225.

In embodiments, the synchronization module 205 may control the transfer of a piece of content from the access point 110 to a station 120. Content received by the access point 110 may be stored at content storage 210. The content stored at content storage 210 may be transcoded from an original format to a format that is compatible with one or more client devices (e.g., stations 120). A station 120 may request, or the access point 110 may be scheduled to transfer a piece of content stored at content storage 210. For example, the synchronization module 205 may receive a request for a piece of content from a station 120 via the wireless interface 215, or the synchronization module 205 may associate with a station 120 and initiate a transfer of a piece of content from the access point 110 to the station 120 at a certain scheduled time. Content may be transcoded by the access point 110 as the content is received by the access point 110, and the transcoded content may be simultaneously or sequentially transferred to a station 120. It should be understood that the access point 110 may receive transcoded content from another device within a subscriber premise (e.g., central media gateway device) or from an upstream server.

In embodiments, the synchronization module 205 may output a piece of content from content storage 210 to a station 120 over a wireless connection established between the access point 110 and station 120 through the wireless interface 215. Communications may be delivered between the access point 110 and one or more stations 120 through a wireless network (e.g., local network 130 of FIG. 1). It should be understood that the wireless network may include any of a variety of wireless networks including, but not limited to a wireless personal area network (PAN), wireless local area network (LAN), and others. It should be further understood that the communications delivered over the wireless network may include any of a variety of communication types including, but not limited to Bluetooth communications, radio communications (e.g., Wi-Fi communications), infrared communications, and others.

A piece of content may be transferred from the access point 110 to a station 120 as a plurality of communications output from the synchronization module 205 through the wireless interface 215. The speed (e.g., data rate, bit rate, etc.) at which the communications are output through the wireless interface may be based upon various factors including, but not limited to, the size of the piece of content being transferred, the bandwidth available to the access point 110 or wireless network over which the content is being transferred, the strength of the signal between the access point 110 and station 120, and others. The strength of the signal between the access point 110 and station 120 may vary depending on various factors such as the distance between the access point 110 and station 120, and the presence of any obstacles (e.g., walls) between the access point 110 and station 120.

In embodiments, the data transfer rate monitor 220 may monitor the rate at which a piece of content is being transferred from the synchronization module 205 to a station 120. It will be appreciated by those skilled in the relevant art that various methods and mechanisms may be used to observe and determine the data rate or bit rate of a data transfer. The data transfer rate monitor 220 may be configured to determine an average data rate for a specific transfer session. For example, when a transfer session between the access point 110 and station 120 begins, the data transfer rate monitor 220 may determine and maintain an average data rate observed for the transfer session.

The data transfer rate monitor 220 may be configured to determine a minimum data transfer rate threshold for a data transfer session. In embodiments, the minimum data transfer rate threshold may be based upon the average data rate for the transfer session and various other factors (e.g., size of content being transferred, bandwidth available, transmission strength at access point 110, etc.). When a data transfer session is initiated or during the early phases of a data transfer session, the minimum data transfer rate threshold may be set as the average bit rate for the monitored transfer session or some percentage of the average bit rate for the monitored transfer session. During later stages of the transfer session, the minimum data transfer rate threshold may be adjusted to a bit rate that might act as a signal of an upcoming or possible disruption to the transfer session. For example, the minimum data transfer rate threshold may be adjusted to a bit rate that might indicate degradation in the strength of the signal between the access point 110 and station 120. It should be understood that the minimum data transfer rate threshold may be dynamically adjusted to account for the bit rate needs of the transfer session and may be based upon various factors including size of the content being transferred, bandwidth available to the access point 110, strength of wireless signal between the access point 110 and station 120, and others. The minimum data transfer rate threshold may be set at any bitrate that is lower than an optimal or preferred bitrate at which the access point 110 is capable of delivering data to the station 120. For example, the minimum data transfer rate threshold may be set at a bitrate that would indicate to a user that content is not being transferred to the station 120 at an optimal or preferred rate.

In embodiments, when the data transfer rate monitor 220 determines that the data rate of a data transfer session has dropped below a minimum data transfer rate threshold associated with the transfer session, the data transfer rate monitor 220 may cause the transfer interruption alert module 225 to generate and output an alert to a station 120. The alert may provide an indication to a user of the degradation in the strength of the signal between the access point 110 and the station 120 to which the content is being transferred. For example, the alert may be a visual output (e.g., graphic, animated graphic, text-based, etc.) or an audio output (e.g., beep, ringtone, etc.). The alert may be a visual and/or audio alert that is output to the station 120 to which content is being transferred, a display device associated with the station 120 to which content is being transferred, or any other device through which a subscriber might receive the alert.

In embodiments, the alert may include instructions or suggestions to assist a user in remedying or preventing the potential disruption to the transfer session. For example, a visual notification may guide a user to a location within a premise where the strength of the signal between the access point 110 and station 120 may be stronger. The visual notification may provide a user with an indication of the current strength of the signal between the access point 110 and the station 120 and may further include an indication of the progress of the current data transfer session.

In embodiments, the output of an alert indicating a potential disruption to the current transfer session may be based upon the progress of the transfer session. For example, the alert may be output to a station 120 or other device associated with the station 120 to which content is being transferred when the data rate of the data transfer falls below the minimum data transfer rate threshold associated with the transfer session and the data transfer session has progressed past a predetermined threshold progress level (e.g., 75%, 80%, 90%, etc.). The predetermined threshold progress level may be based upon the size of the content being transferred, a priority level associated with the piece of content, or other factors.

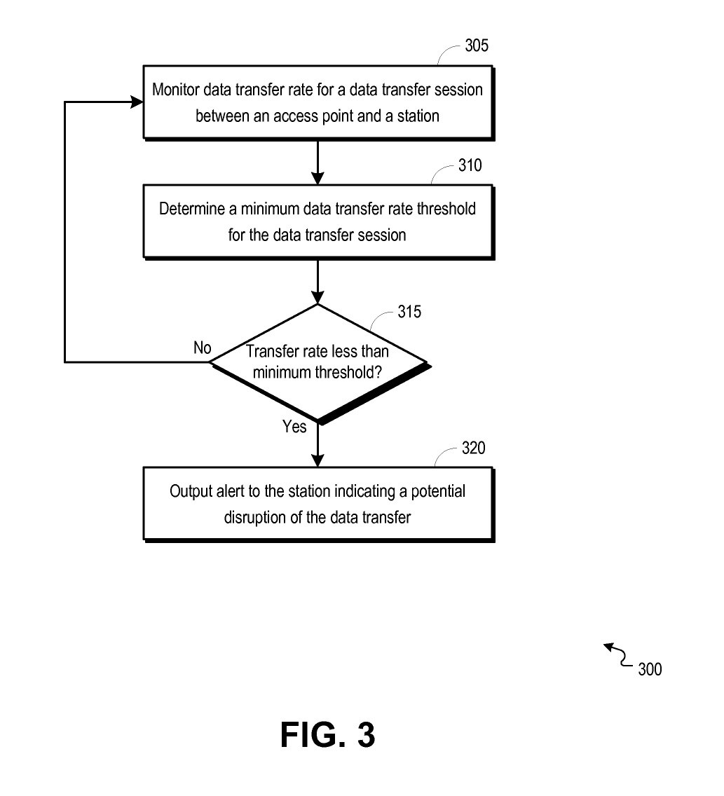

FIG. 3 is a flowchart illustrating an example process 300 operable to facilitate an output of an alert to a device informing a user of a potential data transfer disruption. The process 300 may begin at 305 during a data transfer session between an access point and a station. In embodiments, the data transfer session may be a transfer of content from an access point 110 of FIG. 1 to a station 120 of FIG. 1. For example, a scheduled or unscheduled synchronization operation may be initiated wherein a piece of content stored at the access point 110 is transferred to the station 120 through wireless communications.

At 305, the data transfer rate for the data transfer session may be monitored. The data transfer rate for the data transfer session may be monitored, for example, by the access point 110 (e.g., at the data transfer rate monitor 220 of FIG. 2). In embodiments, a current data transfer rate (e.g., bit rate) for the transfer session may be measured and recorded by the data transfer rate monitor 220.

At 310, a minimum data transfer rate threshold for the data transfer between the access point and the station may be determined. The minimum data transfer rate threshold may be determined, for example, by the access point 110 (e.g., at the data transfer rate monitor 220 of FIG. 2). In embodiments, the data transfer rate monitor 220 may monitor the data rate of the data transfer between the access point 110 and the station 120, and may derive an average data transfer rate from the monitored data rate and/or the progress of the data transfer. The data transfer rate monitor 220 may then derive a minimum data transfer rate threshold based upon the average data transfer rate and/or the progress of the data transfer. For example, in the early stages of a data transfer session, the minimum data transfer rate threshold may be set as the average bit rate for the monitored transfer session or a percentage of the average bit rate, and during later stages of the transfer session, the minimum data transfer rate threshold may be adjusted to a bit rate that might act as a signal of an upcoming or possible disruption to the transfer session. As another example, the minimum data transfer rate threshold may be set as a percentage (e.g., 80%, 75%, 60%, etc.) of the average bit rate for the monitored data transfer session. It should be understood that the minimum data transfer rate threshold may be dynamically adjusted to account for the bit rate needs of the transfer session and may be based upon various factors including size of the content being transferred, bandwidth available to the access point 110, strength of wireless signal between the access point 110 and station 120, and others.

At 315, a determination may be made whether the monitored data transfer rate for the data transfer session is less than the minimum data transfer rate threshold. The determination whether the data transfer rate is less than the minimum data transfer rate threshold may be made, for example, by the access point 110 (e.g., at the data transfer rate monitor 220 of FIG. 2). If the determination is made that the monitored data transfer rate for the data transfer session is not less than the minimum data transfer rate threshold, the process 300 may return to 305 where the access point 110 may continue to monitor the data transfer rate of the data transfer session.

If, at 315, the determination is made that the monitored data transfer rate for the data transfer session is less than the minimum data transfer rate threshold, the process 300 may proceed to 320. At 320, an alert may be output to the station 120, wherein the alert provides an indication of the potential disruption to the data transfer session. The alert may be output from the access point 110, for example, by the transfer interruption alert module 225. In embodiments, the alert may be a visual and/or audio alert that is output to the station 120 to which content is being transferred, a display device associated with the station 120 to which content is being transferred, or any other device through which a subscriber might receive the alert. For example, the alert may be a visual output (e.g., graphic, animated graphic, text, etc.) or an audio output (e.g., beep, ringtone, etc.).

In embodiments, the alert may include instructions or suggestions to assist a user in remedying or preventing the potential disruption to the transfer session. For example, a visual notification may guide a user to a location within a premise where the strength of the signal between the access point 110 and station 120 may be stronger. The visual notification may provide a user with an indication of the current strength of the signal between the access point 110 and the station 120 and may further include an indication of the progress of the current data transfer session. The visual notification may be text based and may instruct the user to move the station 120 to a more suitable location within a premise (e.g., closer to the access point 110). The visual notification may provide an identification of a location within a premise where the station 120 may receive a stronger signal from the access point 110. It should be understood that the output of the alert to the station 120 may continue until the monitored data transfer rate returns to an acceptable level (e.g., greater than the minimum data transfer rate threshold).

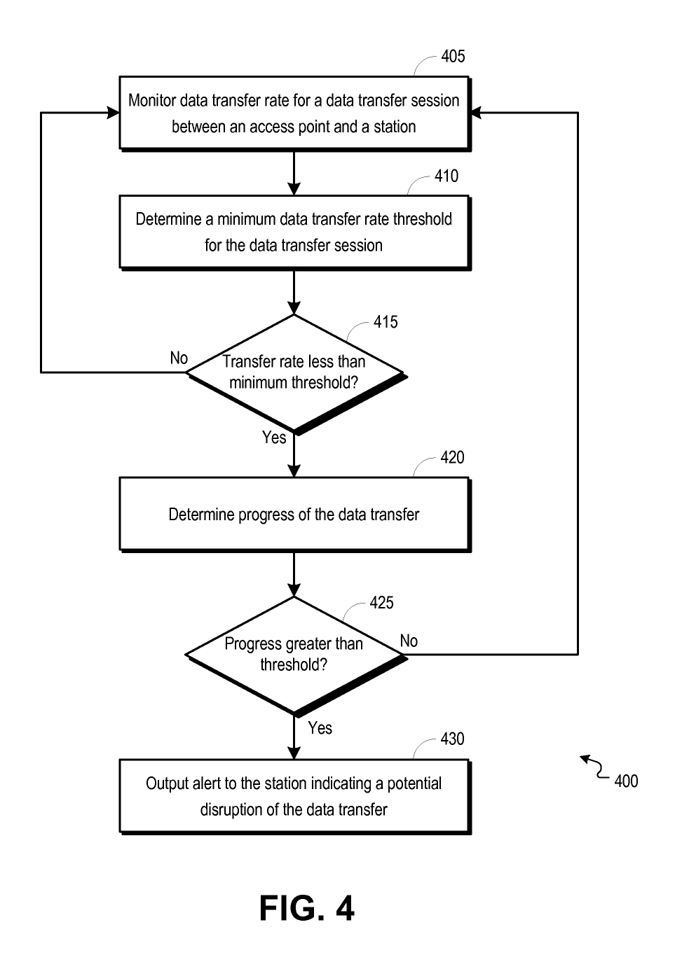

FIG. 4 is a flowchart illustrating an example process 400 operable to facilitate an output of an alert to a device informing a user of a potential data transfer disruption when the transfer has progressed past a certain threshold level. The process 400 may begin at 405 during a data transfer session between an access point and a station. In embodiments, the data transfer session may be a transfer of content from the access point 110 of FIG. 1 to a station 120 of FIG. 1. For example, a scheduled or unscheduled synchronization operation may be initiated wherein a piece of content stored at the access point 110 is transferred to the station 120 through wireless communications.

At 405, the data transfer rate for the data transfer session may be monitored. The data transfer rate for the data transfer session may be monitored, for example, by the access point 110 (e.g., at the data transfer rate monitor 220 of FIG. 2). In embodiments, a current data transfer rate (e.g., bit rate) for the transfer session may be measured and recorded by the data transfer rate monitor 220.

At 410, a minimum data transfer rate threshold for the data transfer between the access point and the station may be determined. The minimum data transfer rate threshold may be determined, for example, by the access point 110 (e.g., at the data transfer rate monitor 220 of FIG. 2). In embodiments, the data transfer rate monitor 220 may monitor the data rate of the data transfer between the access point 110 and the station 120, and may derive an average data transfer rate from the monitored data rate and/or the progress of the data transfer. The data transfer rate monitor 220 may then derive a minimum data transfer rate threshold based upon the average data transfer rate and/or the progress of the data transfer. For example, in the early stages of a data transfer session, the minimum data transfer rate threshold may be set as the average bit rate for the monitored transfer session or a percentage of the average bit rate, and during later stages of the transfer session, the minimum data transfer rate threshold may be adjusted to a bit rate that might act as a signal of an upcoming or possible disruption to the transfer session. It should be understood that the minimum data transfer rate threshold may be dynamically adjusted to account for the bit rate needs of the transfer session and may be based upon various factors including size of the content being transferred, bandwidth available to the access point 110, strength of wireless signal between the access point 110 and station 120, and others.

At 415, a determination may be made whether the monitored data transfer rate for the data transfer session is less than the minimum data transfer rate threshold. The determination whether the data transfer rate is less than the minimum data transfer rate threshold may be made, for example, by the access point 110 (e.g., at the data transfer rate monitor 220 of FIG. 2). If the determination is made that the monitored data transfer rate for the data transfer session is not less than the minimum data transfer rate threshold, the process 400 may return to 405 where the access point 110 may continue to monitor the data transfer rate of the data transfer session.

If, at 415, the determination is made that the monitored data transfer rate for the data transfer session is less than the minimum data transfer rate threshold, the process 400 may proceed to 420. At 420, the progress of the data transfer may be determined. The progress of the data transfer may be determined, for example, by the access point 110 (e.g., at the data transfer rate monitor 220 of FIG. 2).

At 425, a determination may be made whether the progress of the transfer session is greater than a predetermined threshold. The determination may be made, for example, by the access point 110 (e.g., at the data transfer rate monitor 220 of FIG. 2). In embodiments, the access point 110 may compare the measured progress of the transfer session to a predetermined threshold, wherein the predetermined threshold controls the point at which a user is alerted of a potential disruption to a data transfer session. For example, the access point 110 may be configured with a predetermined threshold such that a user is alerted of a potential disruption to a transfer session only when a certain percentage of the transfer session has been completed (e.g., 75%, 80%, etc.). It should be understood that the threshold progress level may be any level of progress or may be set to zero if a user is to receive an alert for every potential disruption to a transfer session regardless of the progress made in the transfer session. It should be further understood that the threshold progress level may be dynamically adjusted based upon the size of a piece of content that is the subject of a data transfer session. If the determination is made that the monitored progress level of the data transfer session is not greater than the progress threshold level, the process 400 may return to 405 where the access point 110 may continue to monitor the data transfer rate of the data transfer session.

If, at 425, the determination is made that the monitored progress level of the data transfer session is greater than the progress threshold level, the process 400 may proceed to 430. At 430, an alert may be output to the station 120, wherein the alert provides an indication of the potential disruption to the data transfer session. The alert may be output from the access point 110, for example, by the transfer interruption alert module 225. In embodiments, the alert may be a visual and/or audio alert that is output to the station 120 to which content is being transferred, a display device associated with the station 120 to which content is being transferred, or any other device through which a subscriber might receive the alert. For example, the alert may be a visual output (e.g., graphic, animated graphic, text, etc.) or an audio output (e.g., beep, ringtone, etc.).

In embodiments, the alert may include instructions or suggestions to assist a user in remedying or preventing the potential disruption to the transfer session. For example, a visual notification may guide a user to a location within a premise where the strength of the signal between the access point 110 and station 120 may be stronger. The visual notification may provide a user with an indication of the current strength of the signal between the access point 110 and the station 120 and may further include an indication of the progress of the current data transfer session. The visual notification may be text based and may instruct the user to move the station 120 to a more suitable location within a premise (e.g., closer to the access point 110). The visual notification may provide an identification of a location within a premise where the station 120 may receive a stronger signal from the access point 110. It should be understood that the output of the alert to the station 120 may be continued until the monitored data transfer rate returns to an acceptable level (e.g., greater than the minimum data transfer rate threshold).

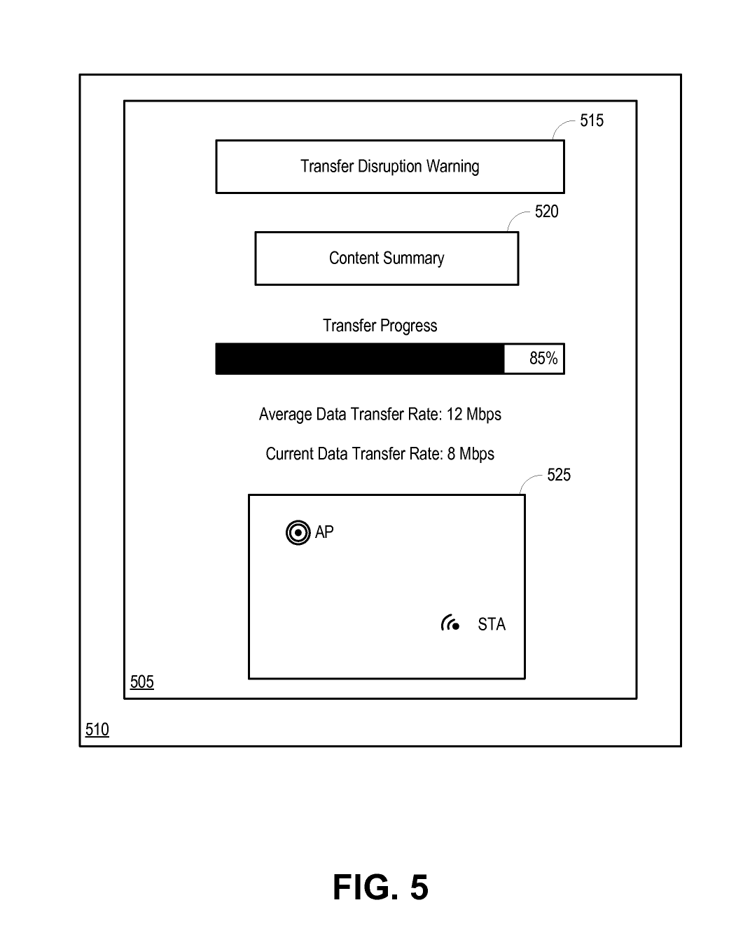

FIG. 5 is an example notification 505 that may provide an indication to a user that a current data transfer may potentially be disrupted. The notification 505 may be output to a display 510 associated with a station (e.g., station 120 of FIG. 1) to which content is currently being transferred from an access point (e.g., access point 110 of FIG. 1). The notification 505 may be output to the display 510 when an access point 110 determines that the data transfer rate for the current transfer session with the station 120 has dropped below a minimum data transfer rate threshold.

In embodiments, the notification 505 may include a transfer disruption warning 515. The transfer disruption warning 515 may provide an indication that a current data transfer session between the associated station 120 and an access point 110 may be disrupted due to the currently observed data transfer rate of the data transfer session. The transfer disruption warning 515 may further indicate to a user that the potential disruption to the current data transfer session may be caused by the current location and/or proximity of the station 120 relative to an access point 110.

In embodiments, the notification 505 may include a content summary 520. The content summary 520 may provide an identification of the content that is currently being transferred to the associated station 120 from the access point 110. For example, the content summary 520 may include various characteristics of the subject content and format of the data being transferred (e.g., title, summary, genre, playback format/resolution, etc.).

In embodiments, the notification 505 may include an indication of the current progress of the data transfer session, the average data transfer rate of the current data transfer session, and the current data transfer rate of the data transfer session.

In embodiments, the notification 505 may include an access point proximity graphic 525. The access point proximity graphic 525 may indicate to a user the location and/or proximity of the associated station 120 relative to an access point 110. For example, the access point proximity graphic 525 may display the location of the station 120 (e.g., STA) relative to the access point 110 (e.g., AP). The access point proximity graphic 525 may include an indication of the strength of the signal between the station 120 and access point 110. In embodiments, the access point proximity graphic 525 may include a layout or floorplan of a premise associated with the access point 110, and the locations of the station 120 and access point 110 may be displayed within the layout or floorplan.

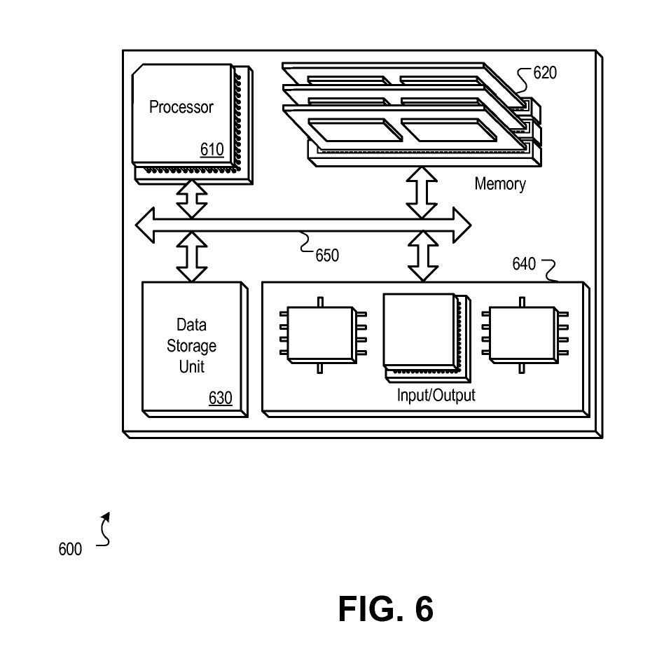

FIG. 6 is a block diagram of a hardware configuration 600 operable to facilitate the output of an alert to a client device informing a user of a potential disruption to a data transfer at a client device. The hardware configuration 600 can include a processor 610, a memory 620, a storage device 630, and an input/output device 640. Each of the components 610, 620, 630, and 640 can, for example, be interconnected using a system bus 650. The processor 610 can be capable of processing instructions for execution within the hardware configuration 600. In one implementation, the processor 610 can be a single-threaded processor. In another implementation, the processor 610 can be a multi-threaded processor. The processor 610 can be capable of processing instructions stored in the memory 620 or on the storage device 630.

The memory 620 can store information within the hardware configuration 600. In one implementation, the memory 620 can be a computer-readable medium. In one implementation, the memory 620 can be a volatile memory unit. In another implementation, the memory 620 can be a non-volatile memory unit.

In some implementations, the storage device 630 can be capable of providing mass storage for the hardware configuration 600. In one implementation, the storage device 630 can be a computer-readable medium. In various different implementations, the storage device 630 can, for example, include a hard disk device, an optical disk device, flash memory or some other large capacity storage device. In other implementations, the storage device 630 can be a device external to the hardware configuration 600.

The input/output device 640 provides input/output operations for the hardware configuration 600. In one implementation, the input/output device 640 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video and/or data services to a central or access device (e.g., access point 110 of FIG. 1, cable modem, router, wireless extender, or other access device) or station 120 of FIG. 1 (e.g., STB, computer, television, tablet, mobile device, etc.). In another implementation, the input/output device can include driver devices configured to send communications to, and receive communications from one or more networks (e.g., WAN 140 of FIG. 1, local network 130 of FIG. 1, provider network 150 of FIG. 1, etc.).

Those skilled in the art will appreciate that the invention described herein improves upon methods and systems for alerting a user of a potential interruption to a data transfer session. Methods, systems, and computer readable media may be operable to facilitate the output of an alert to a client device informing a user of a potential disruption to a data transfer at a client device. An access point may monitor the data rate of a data transfer session with a station, determine a minimum data transfer rate threshold for the data transfer session, and output an alert to the station when the data rate of the transfer session drops below the minimum data transfer rate threshold. The reduced data rate may be caused by a movement of the station away from the access point, and the alert may provide a user with an indication of the reduced data rate. In embodiments, the alert may provide the user with instructions or recommendations for remedying or preventing an interruption to the transfer session.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
monitoring the data rate of a data transfer session, wherein the data transfer session comprises an output of a plurality of data packets to a station, the plurality of data packets being output to the station over a wireless interface;
determining a minimum data rate threshold associated with the data transfer session, wherein the minimum data rate threshold indicates a potential for an interruption to the data transfer session;
determining a current data rate associated with the data transfer session; and
if the current data rate associated with the data transfer session is less than the minimum data rate threshold, outputting an alert to the station, wherein the alert provides an indication of the potential for an interruption to the data transfer session.

2. The method of claim 1, wherein the alert causes an audible indication to be output from the station, the audible indication serving to inform a user that the data transfer session may be interrupted due to the current location of the station with respect to an associated access point.

3. The method of claim 1, wherein the alert causes a visual indication to be output from the station, the visual indication comprising a notification informing a user that the data transfer session may be interrupted due to the current location of the station with respect to an associated access point.

4. The method of claim 3, wherein the visual indication further comprises one or more suggestions for moving the station to prevent the potential interruption to the data transfer session.

5. The method of claim 3, wherein the visual indication further comprises a notification instructing the user to move the station closer in proximity to an associated access point.

6. The method of claim 1, further comprising:
determining an average data rate associated with the data transfer session; and
wherein the minimum data rate threshold is based on the average data rate associated with the data transfer session.

7. The method of claim 1, further comprising:
determining a current progress level associated with the data transfer session; and
if the current progress level associated with the data transfer session is below a predetermined threshold progress level, withholding the output of the alert to the station.

8. An apparatus comprising:
a wireless interface configured to be used to output a plurality of data packets to a station as part of a data transfer session with the station;
one or more modules configured to:
monitor the data rate of the data transfer session;
determine a minimum data rate threshold associated with the data transfer session, wherein the minimum data rate threshold indicates a potential for an interruption to the data transfer session;
determine a current data rate associated with the data transfer session; and
determine that the current data rate associated with the data transfer session is less than the minimum data rate threshold; and
an interface configured to be used to output an alert to the station, wherein the alert provides an indication of the potential for an interruption to the data transfer session.

9. The apparatus of claim 8, wherein the alert causes an audible indication to be output from the station, the audible indication serving to inform a user that the data transfer session may be interrupted due to the current location of the station with respect to an associated access point.

10. The apparatus of claim 8, wherein the alert causes a visual indication to be output from the station, the visual indication comprising a notification informing a user that the data transfer session may be interrupted due to the current location of the station with respect to an associated access point.

11. The apparatus of claim 10, wherein the visual indication further comprises one or more suggestions for moving the station to prevent the potential interruption to the data transfer session.

12. The apparatus of claim 8, wherein the one or more modules are further configured to:
determine an average data rate associated with the data transfer session; and
wherein the minimum data rate threshold is based on the average data rate associated with the data transfer session.

13. The apparatus of claim 8, wherein the one or more modules are further configured to:
determine a current progress level associated with the data transfer session; and
if the current progress level associated with the data transfer session is below a predetermined threshold progress level, withhold the output of the alert to the station.

14. One or more non-transitory computer readable media having instructions operable to cause one or more processors to perform the operations comprising:
monitoring the data rate of a data transfer session, wherein the data transfer session comprises an output of a plurality of data packets to a station, the plurality of data packets being output to the station over a wireless interface;
determining a minimum data rate threshold associated with the data transfer session, wherein the minimum data rate threshold indicates a potential for an interruption to the data transfer session;
determining a current data rate associated with the data transfer session; and
if the current data rate associated with the data transfer session is less than the minimum data rate threshold, outputting an alert to the station, wherein the alert provides an indication of the potential for an interruption to the data transfer session.

15. The one or more non-transitory computer-readable media of claim 14, wherein the alert causes an audible indication to be output from the station, the audible indication serving to inform a user that the data transfer session may be interrupted due to the current location of the station with respect to an associated access point.

16. The one or more non-transitory computer-readable media of claim 14, wherein the alert causes a visual indication to be output from the station, the visual indication comprising a notification informing a user that the data transfer session may be interrupted due to the current location of the station with respect to an associated access point.

17. The one or more non-transitory computer-readable media of claim 16, wherein the visual indication further comprises one or more suggestions for moving the station to prevent the potential interruption to the data transfer session.

18. The one or more non-transitory computer-readable media of claim 16, wherein the visual indication further comprises a notification instructing the user to move the station closer in proximity to an associated access point.

19. The one or more non-transitory computer-readable media of claim 14, wherein the instructions are further operable to cause one or more processors to perform the operations comprising:
determining an average data rate associated with the data transfer session; and
wherein the minimum data rate threshold is based on the average data rate associated with the data transfer session.

20. The one or more non-transitory computer-readable media of claim 14, wherein the instructions are further operable to cause one or more processors to perform the operations comprising:
determining a current progress level associated with the data transfer session; and
if the current progress level associated with the data transfer session is below a predetermined threshold progress level, withholding the output of the alert to the station.
